(19) United States
(12) Patent Application Publication
(10) Pub. No.: US 2005/0195349 A1
(43) Pub. Date: Sep. 8, 2005

(54) Method for fabricating liquid crystal display

(76) Inventor: Yong-Hwan Shin, Suwon-si (KR)

Correspondence Address: MCGUIREWOODS, LLP, 1750 TYSONS BLVD, SUITE 1800, MCLEAN, VA, 22102, US

(21) Appl. No.: 11/071,191

(22) Filed: Mar. 4, 2005

(30) Foreign Application Priority Data
Mar. 5, 2004 (KR) 10-2004-0014886

(51) Int. Cl. G02F 1/1337

(52) U.S. Cl. 349/124

(57) ABSTRACT

A method for manufacturing a multi-domain liquid crystal display with a wide viewing angle is comprised of forming a thin film transistor array panel including a plurality of signal lines, a plurality of pixel regions, a thin film transistor connected with the signal lines, a plurality of pixel electrodes individually formed in the pixel regions, forming an aligning layer on the thin film transistor array panel, dividing each pixel region into multiple domains using the aligning layer and then selectively irradiating unpolarized ultraviolet light thereto, and finally rubbing the aligning layer.

### CROSS REFERENCE TO RELATED APPLICATION

This application claims priority to and the benefit of Korean Patent Application No. 10-2004-0014886 filed on Mar. 5, 2004, which is hereby incorporated by reference for all purposes as if fully set forth herein.

### BACKGROUND OF THE INVENTION

1. Field of the Invention

The present invention relates to a method for fabricating a multi-domain liquid crystal display with a wide viewing angle.

2. Description of the Related Art

Liquid crystal displays (LCDs) are one of the most widely used flat panel display devices. The LCD has a pair of panels each having electrodes on their inner surfaces, and a is liquid crystal layer interposed between the panels. In the LCD, the transmittance of incident light is controlled by aligning liquid crystal molecules in the liquid crystal layer when voltage is applied to the electrodes.

Generally, the most popular LCD comprises a pair of panels on which the electrodes are respectively formed where one of the panels has switching elements such as thin film transistors to control signals applied to the electrodes.

Twisted nematic (TN) mode LCDs utilize twisted nematic liquid crystals with a positive dielectric anisotropy. In the TN mode LCD, when no electric field is applied to the electrodes, the long axes of the liquid crystal molecules interposed between the panels are aligned parallel to the panels and twist spirally with a regular pitch, so that the orientation of the long axes continuously changes. In contrast, when an electric field is applied to the electrodes, the long axes of the liquid crystal molecules are aligned parallel to the electric field and perpendicular to the panels.

However, in such an LCD, the color and the contrast ratio vary remarkably depending on the viewing angle due to the liquid crystal material having an anisotropic refractive index. Therefore the viewing angle may not be very wide and gray conversion may occur.

On the other hand, vertically aligned (VA) mode LCDs with a negative dielectric anisotropy have liquid crystal molecules in the liquid crystal layer interposed between the panels that are aligned perpendicularly to the panels when no electric field is applied to the electrodes. When the electric field is applied to the electrodes, the orientation of the long axes twist continuously between the panels.

The VA mode can obtain a relatively higher contrast ratio compared with the TN mode since it can completely intercept the light leakage in the dark state. However, the VA mode also has the problems that the viewing angle is narrow and gradation conversion can occur since the color and the contrast ratio vary remarkably depending on the viewing angle because the liquid crystal material has an anisotropic refractive index.

In order to solve the above problems, a multi-domain technique has been developed. In a multi-domain TN LCD, the pixel unit is divided into a plurality of domains with different aligning orientations. In the multi-domain VA LCD, the pixel unit is divided into a plurality of domains by forming regular aperture patterns or protrusions in the pixel electrodes and common electrodes facing each other.

However, to make a multi-domain TN mode LCD, each domain is subject to the rubbing treatment to create a different aligning orientation, and afterimages may occur when a photoaligning layer is employed. Also, the process of forming protrusions or apertures may cause stains or afterimages in the protrusions or the aperture patterns, the aperture ratio of pixels or the transmittance of incident light may be degraded, and the response time of liquid crystal may increase. In addition, the production cost increases by the additional step for forming the protrusions or aperture patterns. Due to these problems, this mode is scarcely used.

### SUMMARY OF THE INVENTION

The objective of the present invention is to simplify fabrication process of a multi-domain liquid crystal display.

To achieve this objective, the invention provides a method for fabricating a multi-domain liquid crystal display in which aligning layers are formed with photocrosslinkable photoresistive high molecular weight acrylate-based materials and the pixel unit is divided into multiple-domains by the irradiation of unpolarized ultraviolet light and a rubbing treatment.

One embodiment of the present invention comprises the steps of first forming a thin film transistor array panel that includes a plurality of signal lines, a plurality of pixel regions, a thin film transistor connected to the signal lines, and a plurality of pixel electrodes individually formed in the pixel regions. The next steps are forming an aligning layer on the thin film transistor array panel and then dividing each pixel region into multiple-domains using the aligning layer. Finally, the aligning layer is selectively irradiated using unpolarized ultraviolet light and then rubbed.

Another embodiment of the present invention comprises the steps of first forming an opposite panel that includes a plurality of pixel regions and a common electrode. Next, an aligning layer is formed on the opposite panel and each pixel region is divided into multiple domains using the aligning layer. The aligning layer is then selectively irradiated using unpolarized ultraviolet light and the aligning layer is rubbed.

The aligning layer comprises organic high molecular weight acrylate-based materials including a photocrosslinkable group capable of photodimerization.

It is preferable that the pixel region is divided into two domains and that the alignment directions of the two domains are perpendicular to each other.

At this time, the aligning layer may be in either one of vertically aligned mode or horizontally aligned mode.

It is to be understood that both the foregoing general description and the following detailed description are exemplary and explanatory and are intended to provide further explanation of the invention as claimed.

### BRIEF DESCRIPTION OF THE DRAWINGS

The above objects and other advantages of the present invention will become more apparent by describing the preferred embodiments thereof in more detail with reference to the accompanying drawings.

FIG. 1 is a layout view of a thin film transistor panel for an LCD according to the first exemplary embodiment of the present invention.

FIG. 2 is a layout view of an opposite panel for an LCD according to the first exemplary embodiment of the present invention.

FIG. 3 is a cross-sectional view cut along II-II′ in FIG. 1 showing the structure of an LCD including a TFT panel and an opposite panel according to the first exemplary embodiment of the present invention.

FIG. 4 is a plane view showing alignment directions of aligning layers formed on two panels within a pixel region according to the first exemplary embodiment of the present invention.

FIG. 5 is a layout view of a thin film transistor panel for an LCD according to the second exemplary embodiment of the present invention.

FIG. 6 is a layout view of an opposite panel for an LCD according to the second exemplary embodiment of the present invention.

FIG. 7 is a cross-sectional view cut along VII-VII′ in FIG. 5 showing the structure of an LCD including a TFT panel and an opposite panel according to the second exemplary embodiment of the present invention.

FIG. 8 is a plane view showing alignment directions of aligning layers formed on two panels within a pixel unit according to the second exemplary embodiment of the present invention.

FIG. 9 is a layout view of a TFT panel for an LCD according to the third exemplary embodiment of the present invention.

FIGS. 10A and 10B are cross-sectional views of a TFT panel individually cut along Xa-Xa′ and Xb-Xb′ in FIG. 9.

### DETAILED DESCRIPTION OF THE ILLUSTRATED EMBODIMENTS

Exemplary embodiments of the present invention will now be described more fully hereinafter with reference to the accompanying drawings. The present invention may, however, be embodied in different forms and should not be construed as being limited to the embodiments set forth herein. Rather, these embodiments are provided so that this disclosure will be thorough and complete, and will fully convey the scope of the invention to those skilled in the art.

In the drawings, the thickness of the layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

Hereinafter, methods of manufacturing a TFT panel and an opposite panel for an LCD according to the first embodiment of the present invention will be described in detail with reference to the accompanying drawings.

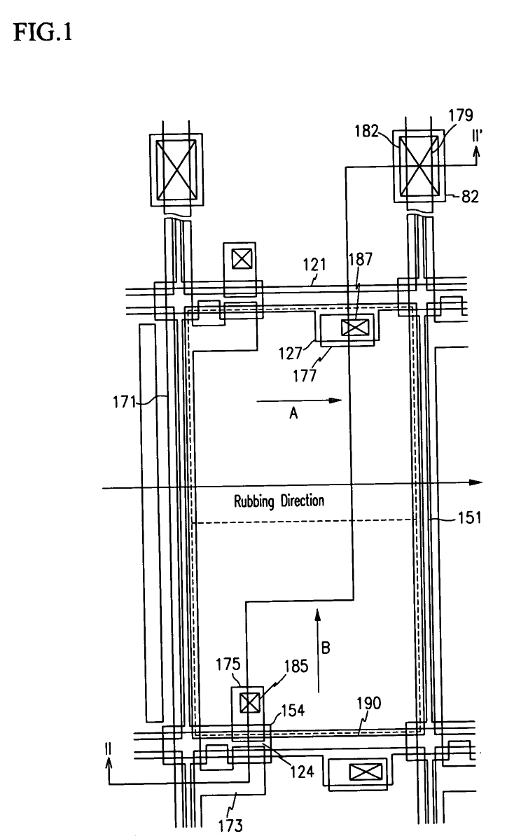

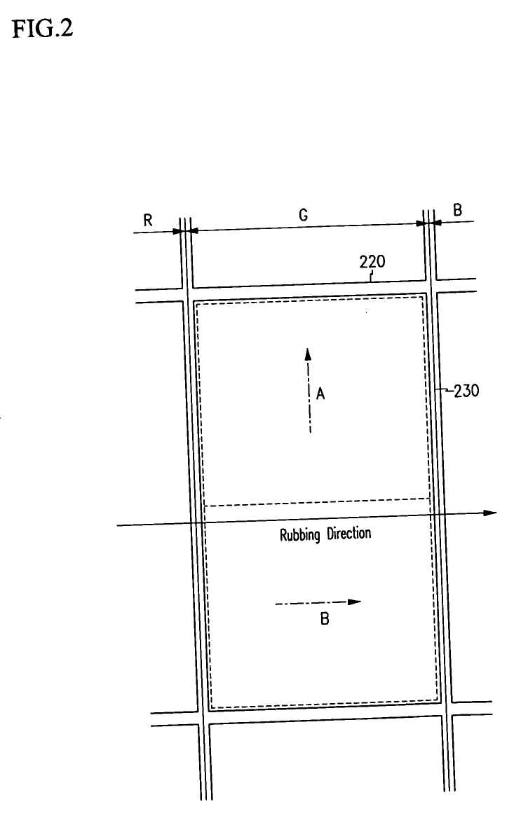

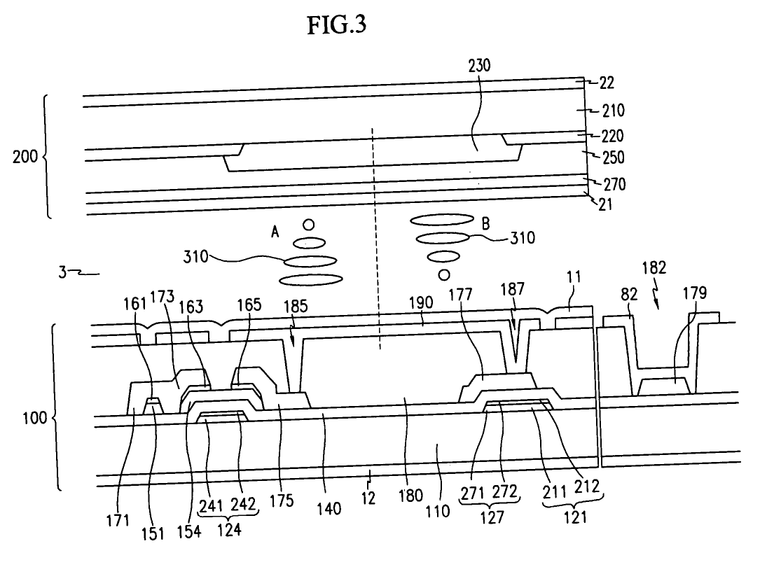

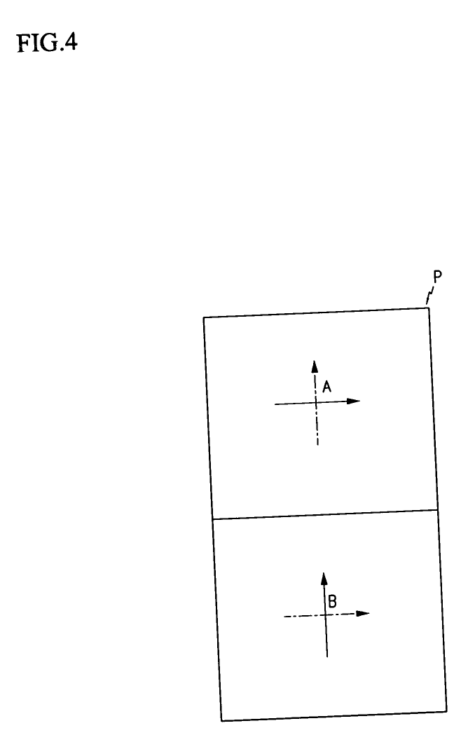

First, configurations of an LCD and two panels applied thereto according to the first embodiment of the present invention will be described with reference to FIG. 1, FIG. 2, FIG. 3 and FIG. 4.

FIG. 1 is a layout view of a thin film transistor panel for an LCD according to the first embodiment of the present invention. FIG. 2 is a layout view of an opposite panel for an LCD according to the first embodiment of the present invention. FIG. 3 is a cross-sectional view cut along II-II′ in FIG. 1 showing the structure of an LCD device including a TFT panel and an opposite panel according to the first embodiment of the present invention. FIG. 4 is a plane view showing alignment directions of aligning layers formed on two panels within a pixel unit according to the first embodiment of the present invention.

Referring to FIG. 3, an LCD of the first embodiment comprises two panels facing each other, a lower-positioned TFT panel 100 and an upper-positioned opposite panel 200, and a liquid crystal layer 3 interposed therebetween. The liquid crystal layer 3 consists of liquid crystal molecules 310 that are aligned parallel to the two panels 100 and 200. The LCD further comprises aligning layers 11 and 21 which are individually formed on the facing inner surfaces of the two panels 100 and 200. Here, the aligning layers of horizontal aligning mode are preferable in order to align the liquid crystal molecules 310 in the liquid crystal layer 3 parallel to the panels 100 and 200, but it is not essential. The LCD further comprises a lower polarizer 12 and an upper polarizer 22, which are individually formed on the outer sides of the opposite panel 200 and the TFT panel 100.

The LCD of the present invention has a multi-domain structure where a pixel unit (P) is divided into at least two or more domains, and in the first embodiment two domains A an B are included in pixel unit (P) as shown in FIGS. 1, 2, and 4. Within the domains A and B, the lower aligning layer 11 of the TFT panel 100 and the upper aligning layer 21 of the opposite panel 200 are mutually crossed perpendicularly. Accordingly, the liquid crystal molecules 310 are arranged in the different direction in the domains A and B depending on the aligning force of the aligning layers 11 and 21 when the electric field is not applied. Also, as shown in FIG. 3, the liquid crystal molecules 310 are parallel to the panels 100 and 200 and twisted helically with a regular pitch, so that the orientations of the long axes of the liquid crystal molecules vary continuously.

At this time, it is preferable that the axes of the two polarizers 12 and 22 are perpendicular to each other. Also, they can be perpendicular to or parallel to the aligning direction of the aligning layers 11 and 21.

In more detail, in the TFT panel as shown in FIGS. 1 and 3, a plurality of gate lines 121 for transmitting gate signals are formed on a lower insulating substrate 110. The gate lines 121 are mainly formed in the horizontal direction and the partial portions thereof become a plurality of gate electrodes 124. Also, the different partial portions thereof which extend in the lower direction become a plurality of expansions 127.

The gate line 121 includes a lower layer 211 and an upper layer 212 which are different in physical characteristics. The upper layer 212 is made of metals having low resistivity, for example, metals such as Al, Al alloy, etc., that reduce gate signal delay or voltage drop. In contrast, the lower layer 211 is made of materials that are prominent in physical, chemical, and electrical contact characteristics with indium zinc oxide (IZO) or indium tin oxide (ITO), such as, chrome (Cr), molybdenum (Mo), or Mo alloys such as Molybdenum-tungsten (MoW). An example of the configuration of the lower layer 211 and upper layer 212 is Cr/Al—Nd. In FIG. 3, the lower layer and the upper layer of each gate electrode 124 are respectively denoted as reference numerals 241 and 242, and the lower layer and the upper layer of each expansion 127 are respectively denoted as reference numerals 271 and 272.

The edge surfaces of the lower and upper layers 211 and 212 are tapered, and the inclination angle of the edge surfaces with respect to a surface of the substrate 110 is in the range of about 30-80 degrees.

A gate insulating layer 140 preferably made of silicon nitride (SiNx) is formed on the gate lines 121.

A plurality of semiconductor stripes 151 preferably made of hydrogenated amorphous silicon (abbreviated to “a-Si”) is formed on the gate insulating layer 140. Each semiconductor stripe 151 extends substantially in the longitudinal direction and is curved periodically. Each semiconductor stripe 151 has a plurality of projections 154 branched out toward the gate electrodes 124. The width of each semiconductor stripe 151 becomes large near the gate lines 121 such that the semiconductor stripe 151 covers large areas of the gate lines 121.

A plurality of ohmic contact stripes and islands 161 and 165 preferably made of silicide or n+ hydrogenated a-Si heavily doped with n type impurity are formed on the semiconductor stripes 151. Each ohmic contact stripe 161 has a plurality of projections 163, and the projections 163 and the ohmic contact islands 165 are located in pairs on the projections 154 of the semiconductor stripes 151.

The edge surfaces of the semiconductor stripes 151 and the ohmic contacts 161 and 165 are tapered, and the inclination angles of the edge surfaces of the semiconductor stripes 151 and the ohmic contacts 161 and 165 are preferably in a range of about 30-80 degrees.

A plurality of data lines 171, a plurality of drain electrodes 175, and a plurality of storage capacitor conductors 177 are formed on the ohmic contacts 161 and 165 and the gate insulating layer 140.

The data lines 171 for transmitting data voltages extend substantially in the longitudinal direction and intersect the gate lines 121 to define pixel areas arranged in a matrix. A plurality of branches of each data line 171, which project toward the drain electrodes 175, form a plurality of source electrodes 173. Each pair of the source electrodes 173 and the drain electrodes 175 is separated from each other and opposite each other with respect to a gate electrode 124. A gate electrode 124, a source electrode 173, and a drain electrode 175 along with a projection 154 of a semiconductor stripe 151 forms a TFT having a channel formed in the projection 154 disposed between the source electrode 173 and the drain electrode 175.

The storage capacitor conductor 177 is overlapped with the expansion 127 of the gate line 121.

Mo and/or Mo alloy are included in the data line 171, the drain electrode 175, and the storage capacitor conductor 177. A conductive layer made of Al series material may be included therein in a double or triple layered structure. In the double-layered structure, it is preferable that the Al series conductive layer is placed under the Mo series conductive layer and in the triple-layered structure it is positioned as an intermediate layer.

The data lines 171, the drain electrodes 175, the storage capacitor conductor 177 have tapered edge surfaces, and the inclination angles of the edge surfaces are in a range of about 30-80 degrees.

The ohmic contacts 161 and 165 are only interposed between the semiconductor stripe 151 and the data line 171 and between the drain electrode 175 and the projection 154 of the semiconductor stripe 151 in order to reduce contact resistance therebetween. The semiconductor stripe 151 is partially exposed at the place between the source electrode 173 and the drain electrode 175 and at the other places, being not covered with the data line 171 and the drain electrode 175. Most of the semiconductor stripe 151 is narrower than the data line 171 but the width of the semiconductor stripe 151 broadens near a place that the semiconductor stripe 151 and the gate line 121 meet each other in order to enhance insulation between the gate line 121 and the data line 171, as mentioned in the above.

On the data line 171, the drain electrode 175, the storage capacitor conductor 177, and the exposed region of the semiconductor stripe 151, a passivation layer 180 is provided, which is made of an organic material having substantial planarization properties and photosensibility or an insulating material with a low dielectric constant such as a-Si:C:O, a Si:O:F, etc. This passivation layer 180 is formed by plasma enhanced chemical vapor deposition (PECVD).

To prevent the organic material of the passivation layer 180 from contacting with the semiconductor strips 151 exposed between the data line 171 and the drain electrode 175, the passivation layer 180 can be structured in a way that an insulating layer made of SiNx or SiO₂ is additionally formed under the organic material layer.

In the passivation layer 180, a plurality of contact holes 185, 187, and 182 are formed to expose the drain electrode 175, the storage capacitor conductor 177, and end portion 179 of the data line 171 respectively. To obtain a structure where the data line includes a contact region and where the data line is connected to the external data driving circuit using an anisotropic conductive layer, this embodiment is constructed in a way that the passivation layer 180 includes the contact holes 182 therein where the end portions 179 of the data lines 171 are exposed to connect with the external data driving circuit as mentioned in the above. The end portions 179 of the data lines 171 are assembled at a data driving circuit connection part and can be formed more widely than the rest portion of the data line 171, if necessary.

Meanwhile, the gate line 121 may also include a contact region at an end portion thereof. For such a structure in this embodiment, the passivation layer 180 also includes a plurality of contact holes to expose the gate insulating layer 140 and the end portions of the gate lines 121. Otherwise, a gate driving circuit may be directly formed on the substrate 110, and the end portions of the gate lines 121 are connected with output terminals of the gate driving circuit.

The contact holes 185, 187, and 182 respectively expose the drain electrode 175, the storage capacitor conductor 177, the end portion 179 of the data line 171. It is preferable that the contact hole does not expose the Al series conductive layer to ensure contact with a subsequently formed conductive layer. If the Al series conductive layer is exposed through the contact hole, it is preferable that the exposed conductive layer is entirely removed by the etching process. At this time, the boundary of the end portion 179 of the data line 171 is exposed through the contact hole 182, and the boundaries of the drain electrode 175 and the storage capacitor conductor 177 are also respectively exposed through the contact holes 187 and 185.

A plurality of pixel electrodes 190 and a plurality of contact assistants 82 which are made of IZO or ITO are formed on the passivation layer 180.

Since the pixel electrode 190 is physically and electrically connected with the drain electrode 175 and the storage capacitor conductor 177 through the contact holes 185 and 187, respectively, the pixel electrode 190 receives the data voltage from the drain electrodes 175 and transmits it to the storage capacitor conductor 177.

The pixel electrode 190 to which the data voltage is applied generates electric field with a common electrode 270 of the opposite panel 200 to which common voltage is applied, so that the liquid crystal molecules 310 in the liquid crystal layer 3 are rearranged.

Also, as mentioned in the above, the pixel electrode 190 and the common electrode 270 form a capacitor to store and to preserve the received voltage after the TFT being off. This capacitor will be referred as a “liquid crystal capacitor.” To enhance the voltage storage ability, another capacitor is provided, which is connected with the liquid crystal capacitor in parallel and will be referred as a “storage capacitor.” The storage capacitor is formed at an overlap portion of the pixel electrode 190 and the adjacent gate line 121 which will be referred to as “previous gate line.” The expansion 127 of the gate line 121 are provided to ensure the largest possible overlap dimension and thus to increase storage capacity of the storage capacitor. The storage capacitor conductor 177 is connected to the pixel electrode 190 and is overlapped with the expansion 127 are provided at the bottom of the passivation layer 180 so that the pixel electrode 190 become closely to the previous gate line 121.

The pixel electrode 190 is overlapped with the adjacent gate line 121 and the adjacent data line 171 to enhance the aperture ratio, but it is not necessarily so.

The contact assistant 82 is connected to the end portion 179 of the data line 171 through the contact hole 182. The contact assistant 82 supplements adhesion between the end portion 179 of the data line 171 and the exterior devices such as the driving integrated circuit and protects them. Accordingly, applying the contact assistant 82 is optional since it is not an essential element. The end portion of the gate line 121 may be connected to the contact assistant 82 through the contact hole in the passivation layer 180.

In another embodiment of the present invention, a transparent conductive polymer is used to form the pixel electrode 190. However, in reflective LCDs, opaque reactive metals can be used. In that case, the contact assistants 81 and 82 can be made of a different material than that of the pixel electrode 190, for example, IZO or ITO.

On the passivation layer 180 on which the pixel electrode 190 and the contact assistant 82 are placed, a lower aligning layer 11 is formed to divide the liquid crystal molecules 310 in the liquid crystal layer 3 into a plurality of domains and to align them. The lower aligning layer 11 is made of photocrosslinkable photosensitive organic high molecular weight acrylate-based materials and it is aligned in the mutually crossed direction (→, ↑) in the domains A and B.

Meanwhile, a black matrix 220 is provided on the opposite panel 200 which is opposite to the TFT panel 100 to prevent the light leakage capable of attacking an upper substrate 210 made of insulating material such as transparent glass, etc. The black matrix 220 is opposite the pixel electrode 190 and includes a plurality of apertures having nearly similar shapes to the pixel electrodes 190.

Also, a plurality of color filters 230 for red, green, and blue are provided on the upper substrate 210 to cover the apertures of the black matrix 220. If the edges of the color filters 230 are overlapped with each other, the light leakage can be blocked. In such a case, the black matrix can be omitted. The color filters 230 proceed in the vertical direction when they are arranged in stripe shape. An overcoat layer 250 made of organic material is formed on the color filters 230.

A common electrode 270 made of transparent material such as ITO, IZO, etc. is provided on the overcoat layer 250, and an upper aligning layer 21 is provided thereon. The upper aligning layer 21 is also made of photosensitive high molecular weight acrylate-based materials and is aligned in the mutually crossed direction (↑, →) in the different domains A and B.

Hereinafter, a method for fabricating an LCD according to the first embodiment of the present invention will be described in detail.

Deposition of conductive layers and insulating layers by the sputtering process, chemical vapor deposition (CVD), and photo-etching are repeatedly performed using photoresist patterns. The layers formed include gate lines 121 individually including a plurality of gate electrodes 124 and a plurality of expansions 127, a gate insulating layer 140, a plurality of linear intrinsic semiconductor strips 151 individually including a plurality of projections 154, a plurality of data lines 171 individually including a plurality of source electrode 173, a plurality of drain electrodes 175, a plurality of storage capacitor conductors 177, a plurality of ohmic is contacts 161 and 165, a passivation layer 180, a plurality of pixel electrodes 190, and a plurality of contact assistants 82.

Subsequently, a lower aligning layer 11 for vertical alignment is formed on a thin film transistor panel 100. A mask having slits for selective ultraviolet light irradiation is disposed on the TFT panel 100 and then unpolarized light is irradiated thereto. Here, the slits are formed so that the incident region is defined in either one of two domains A or B. In this embodiment, the slits are only formed in the mask corresponding to the domain A. Accordingly, the domain A becomes a light irradiated region and the domain B becomes an unirradiated region.

Here, the lower aligning layer 11 is made of organic high molecular weight acrylate-based materials including photocrosslinkable group capable of performing the photodimerization, for example, acrylate-based polymers including chalconyl group, so that it is aligned parallel to the rubbing direction after the unpolarizing ultraviolet light is irradiated thereto and the rubbing process is performed, while being aligned perpendicularly to the rubbing direction after the rubbing process is performed without the irradiation. With the irradiation of ultraviolet light, the chalconyl groups included in the lower aligning layer 11 are crosslinked with each other, thereby performing the photodimerization.

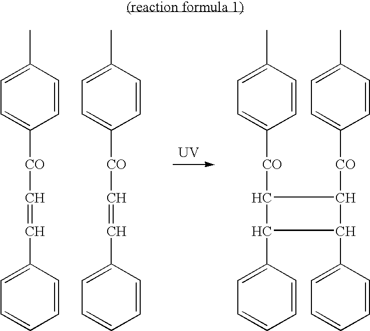

As a result, the chalconyl group as a side chain is arranged perpendicularly to the main chain.

Usable high molecule with the chalconyl group as in chemical formulas. The material of the chemical formula 1 may include glycidylmethacrylate-(4′-methacryloyloxy) chalconyl copolymer. The materials of the chemical formulas 2 to 5 are molecules that have a chalconyl radical. However, the usable materials are not limited thereto.

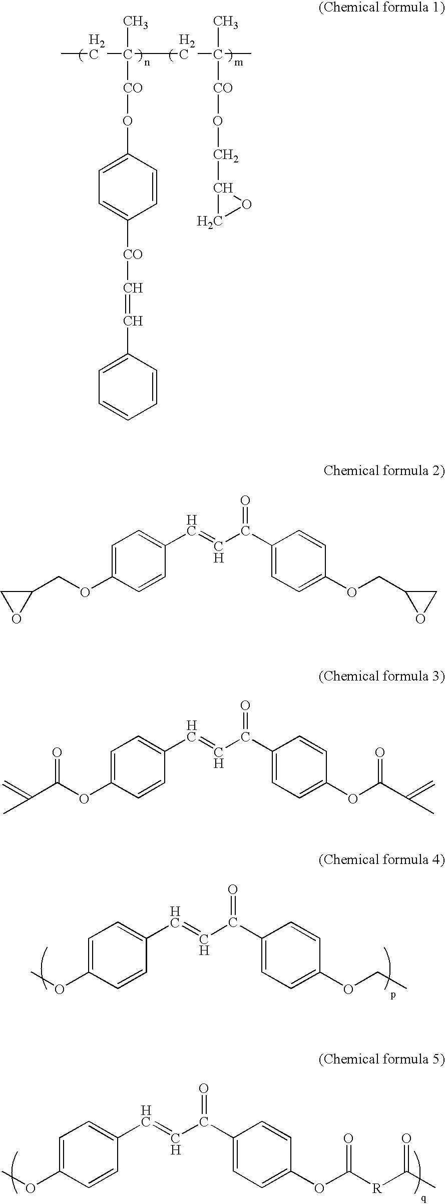

Subsequently, the rubbing process is performed according to an arrow-indicating direction. As a result, the lower aligning layer 11 in the ultraviolet irradiated domain A is aligned parallel to the rubbing direction, while unirradiated domain B is aligned perpendicularly to the rubbing direction as shown in FIG. 1. That is, the lower aligning layer 11 is aligned in different ways with respect to the domains A and B.

A method for fabricating the opposite panel 200 according to the first embodiment of the present invention will be described in the following.

A conductive layer or an insulating layer is first formed by the sputtering process or the CVD process. Then a black matrix 220, color filters 230, an overcoat layer 250, and a common electrode 270 are successively formed by repeating the photoetching process using photoresist patterns.

Subsequently, an upper aligning layer 21 is formed on an opposite panel 200. A mask having slits for selective irradiation of ultraviolet light is disposed on the opposite panel 200 and then unpolarizing ultraviolet light is irradiated thereto. At that time, slits of the mask are formed so that the incident region is defined in either one of the domains A or B, and the mask for the alignment of the upper aligning layer 21 includes the slits in only partial portion thereof corresponding to the domain B, which is different from the mask for the alignment of the lower aligning layer 11. Accordingly, the irradiated region becomes the domain B and the unirradiated region becomes domain A.

The upper aligning layer 21 includes photocrosslinkable photoresistive high molecules like the lower aligning layer 11.

Subsequently, the rubbing process is performed in an arrow-indicated direction as shown in FIG. 2. As a result, the upper aligning layer 21 in the domain A to which no ultraviolet light is applied is aligned perpendicularly to the rubbing direction, while in the domain B to which ultraviolet light is applied the upper aligning layer 21 is aligned parallel to the rubbing direction as shown in FIG. 2. That is, the upper aligning layer 21 is aligned in different ways with respect to the two domains A and B.

As a result, according to the LCD fabricating method of the first embodiment, the multi-domain structure is obtained by the irradiation of unpolarized ultraviolet light and only one rubbing process. Thus, the fabrication process for an LCD having a wide viewing angle is simplified and the production cost is thus minimized.

The alignment method described above is based on the twisted nematic (TN) mode LCD, but it can be applied to the vertically aligned (VA) mode LCD as well.

First, a VA mode LCD configuration according to the second embodiment of the present invention will be described with reference to the drawings.

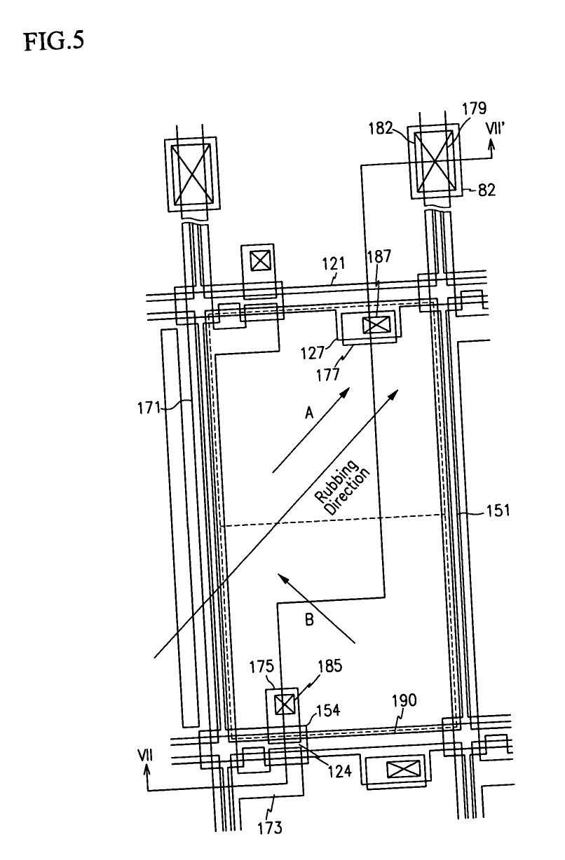

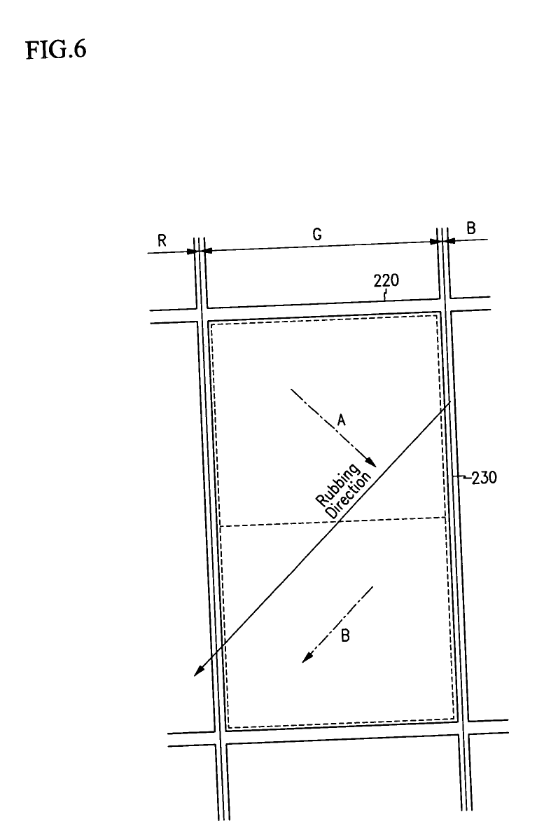

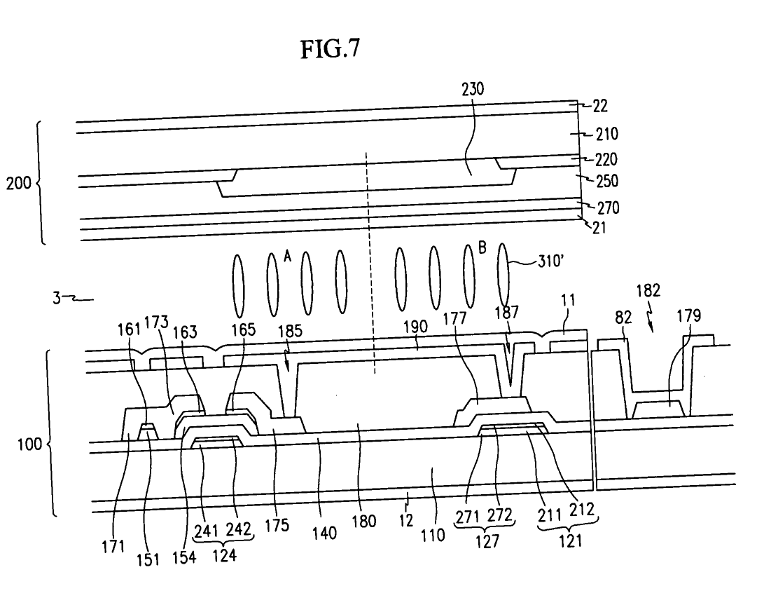

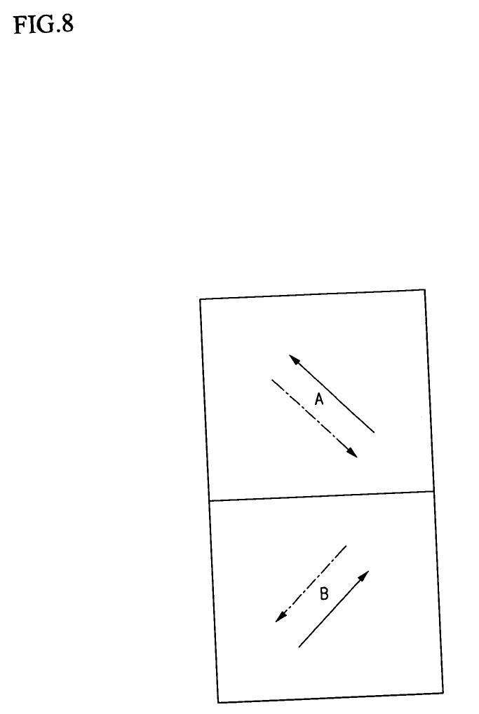

FIG. 5 is a layout view of a thin film transistor panel for an LCD according to the second embodiment of the present invention. FIG. 6 is a layout view of an opposite panel for an LCD according to the second embodiment of the present invention. FIG. 7 is a cross-sectional view cut along VII-VII′ in FIG. 5 showing the structure of an LCD including a TFT panel and an opposite panel according to the second embodiment of the present invention. FIG. 8 is a plane view showing alignment directions of aligning layers formed on two panels within a pixel region according to the second embodiment of the present invention.

The structure of the LCD according to the second embodiment of the present invention shown in FIG. 5 and FIG. 7 is similar to that shown in FIG. 1 and FIG. 3.

However, in this embodiment, liquid crystal molecules 310 in a liquid crystal layer 3 which is interposed between a TFT panel 100 and an opposing panel 200 are aligned perpendicularly to the panels 100 and 200. A lower aligning layer 11 and an upper aligning layer 21 are individually formed on the inner surfaces of the panels 100 and 200. Here, it is preferable that the aligning layers have a vertical alignment force, but it is not essential. This feature is different from the first embodiment.

The LCD device of the present invention has a multi-domain structure that pixel unit (P) is divided into at least two or more domains. In the second embodiment, two domains A an B are included in pixel unit (P) as shown in FIG. 8. Within the domains A and B, the lower aligning layer 11 of the TFT panel 100 has an aligning direction perpendicular to the upper aligning layer 21 of the opposite panel 200. Both of the upper and lower aligning layer 11 and 21 have aligning directions in the diagonal direction as shown in FIG. 8. This feature is different from the first embodiment. Hereinafter, a method for fabricating an LCD according to the second embodiment of the present invention will be described in detail.

First, as in the fabricating method of the first embodiment, a plurality of gate lines 121 individually including a plurality of gate electrodes 124 and a plurality of expansions 127, a gate insulating layer 140, a plurality of intrinsic semiconductor strips 151 individually including a plurality of projections 154, a plurality of data lines 171 individually including a plurality of source electrode 173, a plurality of drain electrodes 175, a plurality of storage capacitor conductors 177, a plurality of ohmic contacts 161 and 165, a passivation layer 180, a plurality of pixel electrodes 190, and a plurality of contact assistants 82 are successively formed on a TFT panel 100.

Subsequently, a lower aligning layer 11 of vertically aligned mode is formed on the TFT panel 100. A mask containing slits for selective ultraviolet light irradiation is disposed on the TFT panel 100 upon which unpolarized ultraviolet light is irradiated thereto. In the mask for the alignment of the lower aligning layer 11, the slits are only formed on regions to corresponding to domain A so that the incident region is defined in domain A. Accordingly, the domain A becomes a light irradiated region and the domain B becomes an unirradiated region.

Here, the lower aligning layer 11 includes photocrosslinkable photoresistive high molecular weight acrylate-based materials like in the first embodiment.

Subsequently, the rubbing process is performed according to an arrow-indicating direction. As a result, the lower aligning layer 11 in the ultraviolet light irradiated domain A is aligned in the rubbing direction ( [symbol] ), while in unirradiated domain B being aligned perpendicularly to the rubbing direction, namely, in the direction of 135 degrees as shown in FIG. 5. That is, the lower aligning layer 11 has different aligning direction in the two domains A and B.

A method for fabricating an opposite panel 200 according to the second embodiment will be described in the following.

A black matrix 220, color filters 230, overcoat layers 250, and a common electrode 270 are successively formed as in the method of the first embodiment.

Subsequently, an upper aligning layer 21 is formed on an opposite panel 200. A mask having slits for selective ultraviolet light irradiation is disposed on the opposite panel 200 and then unpolarizing ultraviolet light is irradiated thereto. In the mask for the alignment of the upper alignment 21, the slits are only formed in the mask corresponding to domain B so that the incident region is defined in domain B, differently from the mask for the alignment of the lower aligning layer 11. Accordingly, domain B becomes a light irradiated region and domain A becomes an unirradiated region.

Here, the upper aligning layer 21 includes photocrosslinkable photoresistive high molecules of acryl series like the lower aligning layer 11.

Subsequently, the rubbing process is performed according to an arrow-indicating direction ( [symbol] ), namely, in the direction of 225 degrees as shown in FIG. 6. Here, the rubbing direction is anti-parallel to the rubbing direction of the lower aligning layer 11. As a result, the is upper aligning layer 21 in the unirradiated domain A is aligned perpendicularly to the rubbing direction, namely, in the direction of 315 degrees ( [symbol] ), while in the irradiated domain B being aligned parallel to the rubbing direction, namely, in the direction of 225 degrees ( [symbol] ) as shown in FIG. 5. That is, the upper aligning layer 21 is differently aligned in the domains A and B.

The first and second embodiments utilize the different masks in the photoetching processes for the formation of the semiconductor layers and the data lines. However, a third embodiment utilizes one photoresist pattern mask for the formation of the semiconductor layers and the data lines to minimize the production cost. This will be described in the following with reference to the drawings.

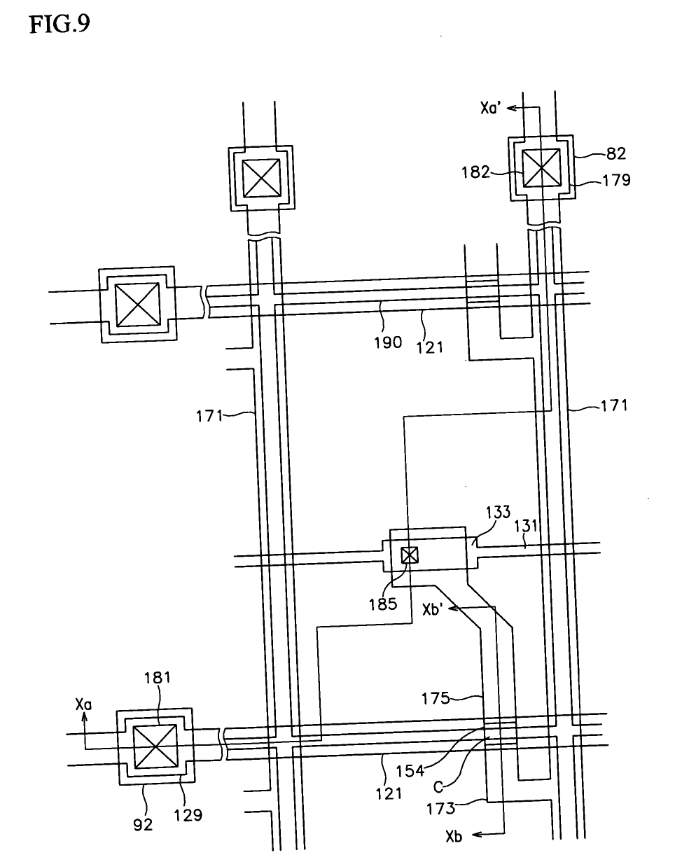

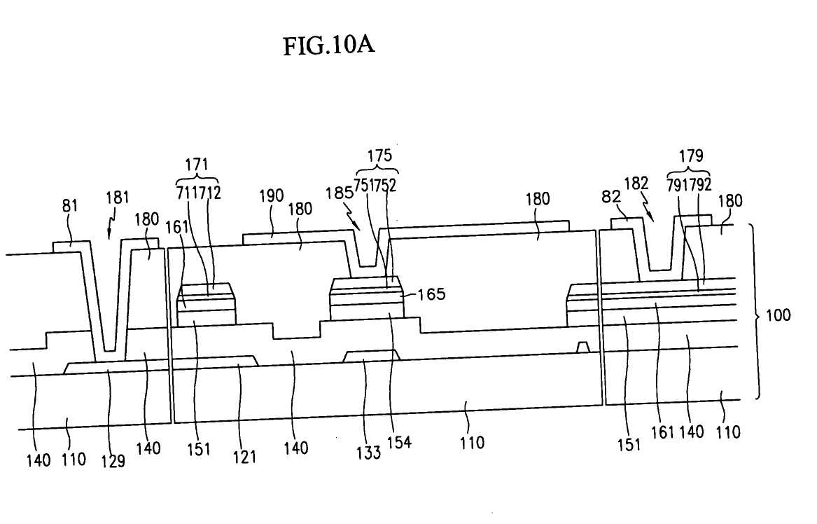

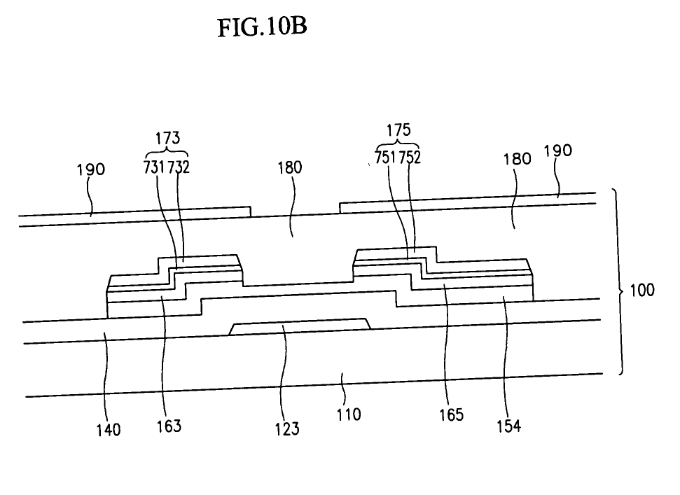

First, the pixel unit configuration employed in a TFT panel for an LCD according to the third embodiment of the present invention will be described in detail with reference to FIG. 9 and FIG. 10A-10B.

FIG. 9 is a layout view of a TFT panel for a LCD according to the third embodiment of the present invention. FIG. 10A and FIG. 10B are cross-sectional views of a TFT panel individually cut along Xa-Xa′ and Xb-Xb′ in FIG. 9.

As shown in FIGS. 9 and 10A-10B, a TFT panel configuration of this embodiment is similar to those of the first and second embodiments. That is, a plurality of gate lines 121 individually including a plurality of gate electrodes 124 are formed on a substrate 110. A gate insulating layer 140, a plurality of semiconductor stripes 151 individually including a plurality of projections 154, and a plurality of linear and island-shaped ohmic contacts 161 and 165 individually including a plurality of extensions 163 are successively formed thereon. A plurality of data lines 171 including a plurality of source electrodes 173, a plurality of drain electrodes 175, a plurality of storage capacitor conductors 177 and a passivation layer 180 are respectively formed on the ohmic contacts 161 and 165 and the gate insulating layer 140. The passivation layer 180 and/or the gate insulating layer 140 include a plurality of contact holes 182, 185, and 187 therein. A plurality of pixel electrodes 190 and a plurality of contact assistants 82 are formed on the passivation layer 180.

However, in contrast with the TFT panel shown in FIGS. 1 and 3, a plurality of storage electrode lines 131 are provided instead of the expansions 127 of the gate line 121 for the formation of the storage capacitor. The storage electrode line 131 is formed on the same layer as the gate line 121 to be electrically separated with the gate line 121. The storage electrode line 131 is overlapped with the drain electrode 175, thereby forming a storage capacitor. The storage electrode line 131 receives a predetermined voltage such as common voltage from the outside. The storage electrode line 131 can be omitted if sufficient storage capacity is given by the overlap of the pixel electrode 190 and the gate line 121, and it can be placed at the boundary of the pixel electrode 190 to enhance the aperture rate.

The semiconductor strip 151 has the practically same plane shape as the data line 171, the drain electrode 175, and the ohmic contacts 161 and 165, except for the projection 154 thereof. In more detail, the projection 154 of the linear semiconductor strip 151 is partially exposed between the source electrode 173 and the drain electrode 175, being uncovered with the data line 171, the drain electrode 175, and the ohmic contacts 161 and 165.

Also, the gate line 121 includes a driving circuit connection part at an end portion 129 thereof. The end portion 129 is exposed through a contact hole 181 formed in the gate insulating layer 140 and the passivation layer 180, so that it is connected with the contact assistant 81 on the passivation layer 180 through the contact hole 181.

As mentioned in the above, the present invention can fabricate a multi-domain LCD with the irradiation of unpolarizing ultraviolet light and once rubbing process. Accordingly, the fabrication process of the LCD having wide viewing angle is simplified and the production cost is also minimized.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

1. A method for fabricating a liquid crystal display, comprising:
forming a thin film transistor array panel including a plurality of signal lines, a pixel region, a thin film transistor coupled with the signal lines, and a pixel electrode formed in a pixel region;
forming an aligning layer on the thin film transistor array panel;
selectively irradiating unpolarized ultraviolet light to the aligning layer to divide a pixel region into multiple domains; and
rubbing the aligning layer.

2. The method of claim 1, wherein the aligning layer is formed with organic high molecular weight acrylate-based materials including a photocrosslinkable group capable of photodimerization.

3. The method of claim 1, wherein the pixel region is divided into two domains.

4. The method of claim 1, wherein alignment directions of the two domains are mutually crossed perpendicularly.

5. The method of claim 1, wherein the aligning layer is formed in a vertically aligned mode.

6. The method of claim 1, wherein the aligning layer is formed in a horizontally aligned mode.

7. A method for fabricating a liquid crystal display, comprising:
forming a common electrode on a substrate that has a pixel region;
forming an aligning layer on the common electrode;
selectively irradiating unpolarized ultraviolet light to the aligning layer to divide a pixel region into multiple domains; and
rubbing the aligning layer.

8. The method of claim 7, wherein the aligning layer is formed with organic high molecular weight acrylate-based materials including photocrosslinkable group capable of photodimerization.

9. The method of claim 7, wherein the pixel region is divided into two domains.

10. The method of claim 7, wherein alignment direction of the two domains are mutually crossed perpendicularly.

11. The method of claim 7, wherein the aligning layer is formed in a vertically aligned mode.

12. The method of claim 7, wherein the aligning layer is formed in a horizontally aligned mode.
